(19) United States
(12) Patent Application Publication
(10) Pub. No.: US 2020/0191260 A1
(43) Pub. Date: Jun. 18, 2020

(54) VOICE SHIFTING

(71) Applicant: ZF Friedrichshafen AG, Friedrichshafen (DE)

(72) Inventor: Knut SCHWARZ, Bad Essen (DE)

(73) Assignee: ZF Friedrichshafen AG, Friedrichshafen (DE)

(21) Appl. No.: 16/619,352

(22) PCT Filed: May 8, 2018
(86) PCT No.: PCT/EP2018/061741

§ 371 Date: Dec. 4, 2019

(30) Foreign Application Priority Data
Jun. 7, 2017 (DE) 10 2017 209 531.8

(51) Int. Cl. F16H 59/08; F16H 61/02; F16H 61/16

(52) U.S. Cl. CPC F16H 59/08; B60R 16/0373; F16H 61/16; F16H 61/0204

(57) ABSTRACT

The invention relates to a system for a vehicle comprising an audio detection unit, an operation device, which is separate from the audio detection unit, and a transmission module for transferring torque, wherein the audio detection unit and an operation device transmit control signals to the transmission module for initializing an operational mode, wherein a processing unit is embodied to differentiate between a control signal received by the transmission module from the operation device and a control signal received by the transmission module from the audio detection unit, and wherein when transmission module receives the respective control signals simultaneously the processing unit prioritizes the control signal from the operation device, such that the transmission module implements an operational mode accordingly.

### RELATED APPLICATIONS

This application is a filing under 35 U.S.C. § 371 of International Patent Application PCT/EP2018/061741, filed May 8, 2018, claiming priority to German Patent Application 10 2017 209 531.8, filed Jun. 7, 2017. All applications listed in this paragraph are hereby incorporated by reference in their entireties.

### TECHNICAL FIELD

The invention relates to a system for a vehicle comprising an audio detection unit, an operation device, which is separate from the audio detection unit, and a transmission module for controlling the transfer of torque, wherein the audio detection unit and an operation device are each embodied to transmit control signals to the transmission module for initializing an operational mode of the transmission module.

### BACKGROUND

A system of this kind is disclosed in the U.S. Pat. No. 8,065,063 B2. Here a system is disclosed for shifting an automatic transmission module for transferring torque in a vehicle, wherein a voice recognition program signals the transmission module on the basis of a driver's vocal command. The system can comprise an additional pedal or switch for activating or deactivating the voice recognition system. The system further discloses an algorithm to protect the transmission module and motor of the vehicle by only implementing vocal commands that are mechanically safe.

However, there are still many safety issues involved with the use of voice recognition for safety critical applications in vehicles. Erroneous or unexpected gear shifting can have serious ramifications for the safety of occupants of a vehicle as well as for other passive and/or active participants in traffic related situations.

### SUMMARY

The object of the invention is therefore to introduce a system comprising an audio detection unit for shifting in a vehicle that provides increased safety.

The object of the invention is achieved by a system defined according to the subject matter of the independent claim. The dependent claims and the description define advantageous embodiments of the system.

The object is therefore achieved by a system for a vehicle comprising an audio detection unit, an operation device, which is separate from the audio detection unit, and a transmission module for transferring torque, wherein the audio detection unit and an operation device are each embodied to transmit control signals to the transmission module for initializing an operational mode of the transmission module, wherein the audio detection unit and the operation device are each connected directly to the transmission module via at least one communications pathway, and wherein the transmission module comprises a processing unit, wherein the processing unit is embodied to differentiate between a control signal received by the transmission module from the operation device and a control signal received by the transmission module from the audio detection unit, and wherein when transmission module receives the respective control signals simultaneously and/or successively within a time span of predetermined length, the processing unit is embodied to prioritize the control signal from the operation device and disregard the control signal from the audio detection unit, so that the transmission module implements an operational mode according to the control signal from the operation device.

The operation device can therefore always be used to override any command signal originating from the audio detection unit, providing a driver of the vehicle a level of certainty regarding the reaction of the transmission module to a given command signal. Furthermore, since an audio detection unit can be controlled from anywhere in the vehicle, the invention provides a driver of the vehicle with a method for simply overriding any audio command signals that originate, for example, from another passenger of the vehicle.

The transmission module can comprise an automatic transmission having operational modes such as drive, reverse, neutral, and park, for example. The transmission module can furthermore comprise an electronics unit that comprises a processor. Automatic transmissions are increasingly operated in so-called shift-by-wire systems, wherein control signals are transmitted to the transmission module and actuators of the transmission module act to change the configuration of the transmission module correspondingly.

The audio detection unit can be a voice recognition system, for example, comprising a microphone for transducing audio signals to electrical signals, and a processing unit for evaluating the electrical signals, as well as for outputting electrical control signals. The electrical control signals output by an audio detection unit have conventionally been used to control infotainment systems and/or functions involving telephony and/or navigation in automobiles.

In an advantageous embodiment of the system, the audio detection unit is embodied to detect at least a first predetermined audio command signal and a second predetermined audio command signal, in particular vocal signals of an operator of the vehicle, and wherein the audio detection unit is embodied to transmit at least a first control signal and a second control signal, wherein the control signals correspond respectively to the first and second predetermined audio command signals, wherein the audio detection unit is embodied to transmit the second control signal exclusively when a pre-determined operation mode of the transmission module is currently engaged.

The control signals carry instructions which can be interpreted by the processing unit of the transmission module of the vehicle for engaging a certain operation mode. The processing unit of the transmission module can transmit a signal to the audio detection unit that carries information regarding the current operation mode engaged in the transmission module. The audio detection unit is embodied to take the information regarding the current operation mode of the transmission into account, while preparing a control signal. If a certain operation mode of the transmission module is currently engaged while the audio detection unit is preparing a control signal for transmission to the transmission module, then the audio detection unit will proceed to transmit the control signal or not proceed to transmit the control signal depending on the operation mode currently engaged.

For example, when the first control signal carries instructions for engaging a neutral operation mode, where no torque is transferred, and the second control signal carries instructions to engage a reverse operation mode, then the second control signal will only be transmitted when the transmission module is currently engaged in a neutral operation mode, so that the transmission module is not damaged. The first control signal for engaging the neutral operation mode will be transmitted by the audio detection unit while taking into account the information regarding the currently engaged operational mode, since engaging neutral will present no danger to the transmission module.

In another example, when the audio detection unit detects an audio command for changing the operational mode from a first drive operation mode to a second drive operation mode, e.g. from a first gear level to a second gear level, the corresponding control signal will only be transmitted to the transmission module when an operational mode for manual shifting is currently engaged. Such an operation mode for manual shifting of an automatic transmission is sometimes referred to as a semi-manual mode, quasi-manual mode, and/or tipping-mode. In this mode, the transmission does not automatically change gears, i.e. the levels of torque transmission ratio of the transmission module. Rather, a current torque transmission ratio, i.e. gear, is selected and/or specified by an operator.

In an embodiment of the invention the audio detection unit is embodied to perform a biometric analysis of a detected audio signal. The biometric analysis can be used to create a databank of operator specific audio commands; such that the audio detection unit can later verify that the operator of the vehicle is providing the audio signal, as opposed to a passenger. The biometric analysis can also be used to analyze age, sex, stress levels as well as other vocal metrics, i.e. aspects of audio signals input from the vehicle operators. Such information can be used to adapt algorithms in the audio detection unit in order to increase its effectiveness in recognizing audio commands. The audio detection unit can furthermore, for example, carry out a biometric analysis of a vocal signal, and reject the input when the vocal signal is considered to be the vocal signal of a child, or of someone whose ability to operate a vehicle is impaired because they are under the influence of a substance, emotionally impaired and/or tired.

In an embodiment of the invention the audio detection unit is embodied to perform a biometric comparison of a received voice audio signal on the basis of biometric information stored in the audio detection unit. This comparison can be used to identify and implement audio signals originating from a specific operator as well as to screen out audio signals not originating from the specific operator.

In an embodiment of the invention the audio detection unit is embodied to transmit a signal to the transmission module on the basis of the biometric analysis and/or biometric comparison indicating that the transmission module should disregard control signals from the audio detection unit for a predetermined amount of time and/or until the audio detection unit transmits a further signal indicating that the transmission module should again regard control signals from the audio detection unit. The audio detection unit can thereby be “turned off” for a certain period of time. The audio detection unit can also independently lock itself under certain conditions, for example, when someone under the influence of alcohol attempts to operate the vehicle.

In an embodiment of the System at least one of the at least one communications pathways is embodied as a data bus, in particular a CAN-Bus. Alternatively, the communications pathway can comprise another data bus such as a LIN-Bus, Flexray-Bus, etc. The operation device can be connected to the transmission module via a first data Bus, while the audio detection unit can be connected to the transmission module via a second data Bus. Alternatively, both the operation device and the audio detection unit can be connected to the transmission module via a single data Bus.

In an embodiment of the System the audio detection unit comprises at least an operation mode and a configuration mode, wherein in an operation mode the audio detection unit serves to detect the predetermined audio signal and transmit the transmission control signal, and in a configuration mode, the audio detection unit is embodied to record an operator specified audio signal for use as the predetermined audio signal. An operator can therefore personalize the audio signals for inputting commands. For example, for making selections in an operation mode of the transmission module wherein the forward drive gear is engaged and can be adjusted up or down in a quasi-manual way, an operator can configure the audio detection unit to recognize audio commands such as “Tip Up” and “Tip Down”.

In an embodiment of the System the operation device comprises a sensor for sensing contact of the operation device by the operator, and the operation device is embodied to transmit a signal to the transmission module indicating the contact is established, and the processing unit of the transmission module is embodied to disregard all signals from originating from the audio detection unit for a predetermined period of time after the reception of such a signal.

In an embodiment of the System the operation device comprises a sensor for sensing contact of the operation device by the operator, and the operation device is embodied to transmit a signal to the transmission module indicating the contact is established, and in that the processing unit of the transmission module is embodied to disregard all signals from originating from the audio detection unit until the operation device transmits a second signal indicating that contact by the operator has been removed. The transmission module can therefore be embodied to disregard all signals from the audio detection unit until a release signal is transmitted from the operation device indicating that contact with the operation device has been removed. The transmission module will in this case only respond to signals from the audio detection unit when the operator of the vehicle is not contacting the operation device.

In an embodiment of the System the processing unit of the transmission module is embodied to perform a plausibility check on the control signals received. A plausibility check can be, for example, a verification that the control signal received by the transmission module, for example over a CAN-Bus, was transmitted by the audio detection unit or the operation device, through a comparison with stored parameters in the transmission module. An example of a plausibility check would be for example to check the time interval between reception of the control signal and the reception of a previous control signal. If the time interval is smaller than a time threshold stored as a parameter in the transmission module, then the control signal fails the plausibility check given that a certain amount of time is required to input a command into either the operation device or the audio detection unit.

In an embodiment of the System the audio detection unit is embodied to only transmit a control signal when a drive gear of the transmission is engaged in accordance with a control signal transmitted by the operation device. A system embodied in this way can be used for quasi-manually shifting up and/or down.

In an embodiment of the System the communications pathway comprises a gateway. For example, the audio detection unit might be connected to a first bus system of a first type and the operation device might be connected to the transmission module via a second bus system of a second type. The two bus systems can be integrated by means of the gateway, permitting the audio detection unit to transmit messages on the second bus.

### BRIEF DESCRIPTION OF THE DRAWINGS

Embodiments of the system will next be described more closely on the basis of the following figures.

FIG. 1 shows a schematic layout of a vehicle comprising an embodiment of the system;

FIG. 2 shows a block diagram of the functional components of an embodiment of the system; and

FIG. 3 shows a block diagram of the functional components of an embodiment of the system.

### DETAILED DESCRIPTION

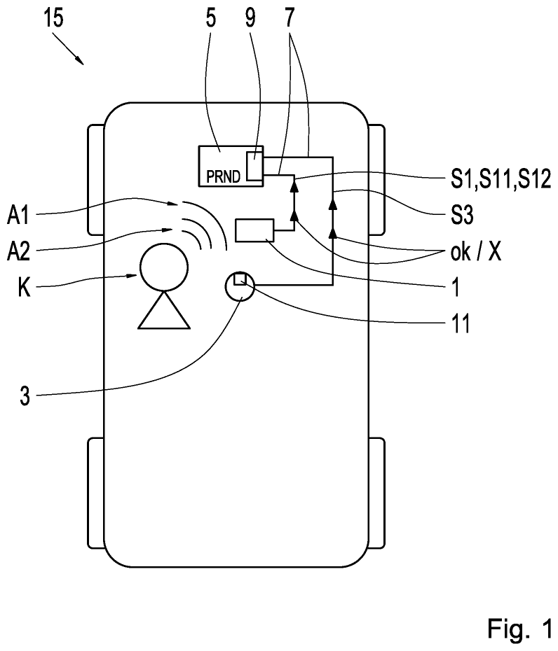

FIG. 1 shows a schematic layout of a vehicle 15 comprising an embodiment of the system. An operator K of the vehicle is situated in the vehicle 15 gives audio commands A1, A2. Centered in the vehicle 15 is an operation device 3. The operation device 3 is connected to a transmission module 5 via a communications pathway 7. The communications pathway 7 is a CAN-Bus. The transmission module 5 comprises a processor unit 9.

An audio detection unit 1 is displayed. The audio detection unit 1 comprises a transducer (not shown) that serves to convert audio signals A1, A2 into electrical signals. Further, the audio detection unit 1 comprises a processing unit (not shown) to process and analyze the electrical signals.

Both the operation device 3 and the audio detection unit 1 are capable of sending or transmitting electrical signals S1, S3, Ok, X to the transmission module. These electrical signals S1, S3, Ok, X, in part referred to as control signals S1, S3, carry information. The information encoded into these signals S1, S3, OK, X is received and interpreted by the processing unit 9 of the transmission module 5. The control signals S1, S3 indicate to the transmission module 5 an operator's input command A1, A2 regarding a presently desired configuration of the transmission module 5. In other words, the signals contain information that the transmission module 5 interprets as an actionable command to control certain actuators in such a way that an operation mode such as a drive operation mode D, D1, D2, park P, reverse R, etc. is engaged.

It is possible for the operation device 3 and the audio detection unit 1 to both transmit control signals S1, S3 at the same time, for instance because the operator K or driver of the vehicle 15 has physically manipulated the operation device 3 in order to send a shift command A1, A2 to the transmission module 5, while at the same time, a passenger of the vehicle has given an audible command that is interpreted by the audio detection unit 1 as shift command A1, A2. If the transmission module 5 receives a control signal S3 from the operation device 3, this signal will be implemented by the transmission module 5. If the transmission module 5 receives a control signal S1 from the audio detection unit 1 at the same time that it receives a control signal S3 from the operation device 3, then this control signal S1 from the audio detection unit 1 will not be implemented. Furthermore, the signal S1 from the audio detection unit 1 will not be implemented if it is received within a predetermined time span that spans the arrival of the control signal S3 from the operation device 3. That is, when the control signal S1 is received from the audio detection unit 1, the processor 9 of the transmission module 5 first examines a message history of received signals in a memory unit of the transmission module 5 to verify that no control signals S3 have been received from the operation device 3 within the last T seconds, where T can be determined according to safety requirements or other operator K preferences. T can also be for example 0.5. The transmission module 5 further delays implementing the control signal S1 from the audio detection unit 1 for a time period Y seconds, wherein Y is predetermined, according to said safety requirements or operator K preferences. During this time period Y seconds of delay, the transmission module 5 monitors incoming control signals S1, S3. If a control signal S3 from the operation device 3 is received during this time period, then transmission module 5 will not implement the control signal S1 from audio detection unit 1.

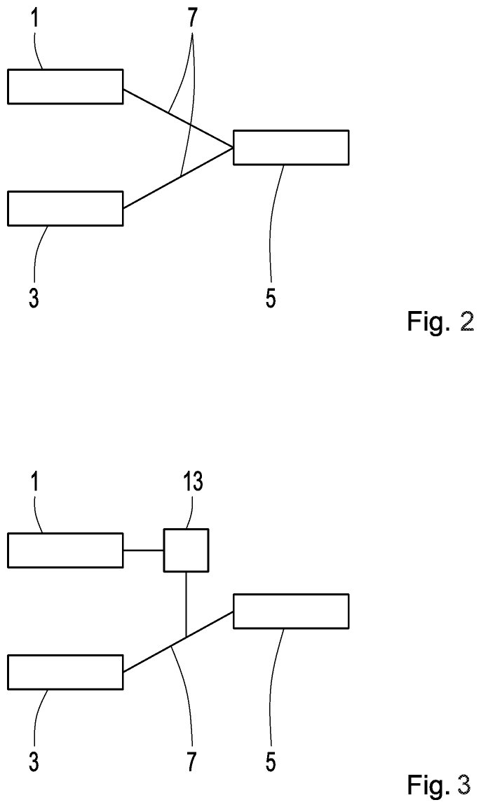

FIG. 2 shows a block diagram of the functional components of an embodiment of the system. The audio detection unit 1 and the operation device 3 are both connected independently to the transmission module 5. The connections 7 are bus systems. The bus system connecting the operation device 3 can be subject to higher safety requirements than the bus system connecting the audio detection unit 1. Generally, the audio detection unit 1 can be used for various other purposes, such as for example, inputting commands to a media system, for selecting music, or for controlling a mobile communications device through a Bluetooth interface.

FIG. 3 shows block diagram of the functional components of an embodiment of the system, wherein the audio detection unit 1 is connected to a gateway 13 which is in turn integrated in the bus system 7 connecting the operation device 3 to the transmission module 5. This permits the audio detection unit 1 to be connected to a completely different communication bus having a different architecture or protocol, while preserving the ability of the audio detection unit 1 to transmit control signals S1, S11, S12 to the transmission module 5.

### REFERENCE CHARACTERS

1 audio detection unit
3 operation device
5 transmission module
7 communications pathway
9 processing unit of the transmission module
11 sensor
13 gateway
15 vehicle
K operator
A1, A2 audio commands
S1 control signal from audio detection unit
S11 control signal from audio detection unit
S12 control signal from audio detection unit
S3 control signal from operation device
P, R, N, D, D1, D2 operational modes

1. A system for a vehicle comprising:
an audio detection unit;
an operation device, which is separate from the audio detection unit; and
a transmission module for transferring torque;
wherein the audio detection unit is configured to transmit a first control signals to the transmission module, and wherein the operation device is configured to transmit a second control signal to the transmission module, the first control signal and the second control signal for initializing an operational mode of the transmission module,
wherein the audio detection unit and the operation device are each connected directly to the transmission module via at least one communications pathway,
wherein the transmission module comprises a processing unit configured to:
differentiate between the second control signal received by the transmission module from the operation device and the first control signal received by the transmission module from the audio detection unit; and
prioritize the second control signal from the operation device and disregard the first control signal from the audio detection unit, such that the transmission module implements an operational mode according to the second control signal from the operation device, in response to the transmission module receiving the second control signal and the first control signal at least one of simultaneously or successively within a time span of a predetermined length.

2. The system according to claim 1, wherein the audio detection unit is configured to:
detect at least a first predetermined audio command signal and a second predetermined audio command signal, the first predetermined audio command signal and the second predetermined audio command signal comprising vocal signals of an operator of the vehicle; and
to transmit at least a third control signal and a fourth control signal, wherein the third control signal corresponds to the first predetermined audio command signal and wherein the fourth control signal corresponds to the second predetermined audio command signals, wherein the audio detection unit is configured to transmit the fourth control signal exclusively when a predetermined operation mode of the transmission module is currently engaged.

3. The system according to claim 1, wherein the audio detection unit is configured to perform a biometric analysis of a detected audio signal.

4. The system according to claim 1, wherein the audio detection unit is configured to perform a biometric comparison of a received voice audio signal on a basis of biometric information stored in the audio detection unit.

5. The system according to claim 1, wherein the audio detection unit is configured to transmit a third control signal to the transmission module on a basis of at least one of a biometric analysis ora biometric comparison, the third control signal indicating that the transmission module should disregard other control signals from the audio detection unit at least one of for a predetermined amount of time or until the audio detection unit transmits a fourth control signal indicating that the transmission module should again regard other control signals from the audio detection unit.

6. The system according to claim 1, wherein at least one of the at least one communications pathways is configured as a data bus.

7. The system according to claim 1, wherein the audio detection unit comprises at least an operation mode and a configuration mode, wherein, when in the operation mode, the audio detection unit is configured to detect a predetermined audio signal and transmit a third control signal, and when in a configuration mode, the audio detection unit is configured to record an operator specified audio signal for use as the predetermined audio signal.

8. The system according to claim 1,
wherein the operation device comprises a sensor for sensing contact of the operation device by an operator of the vehicle,
wherein the operation device is configured to transmit a contact signal to the transmission module indicating the contact is established, and
wherein the processing unit of the transmission module is configured to disregard all signals originating from the audio detection unit for a predetermined period of time after receiving the contact signal.

9. The system according to claim 1,
wherein the operation device comprises a sensor for sensing contact of the operation device by an operator of the vehicle,
wherein the operation device is configured to transmit a contact signal to the transmission module indicating the contact is established, and
wherein the processing unit of the transmission module is configured to disregard all signals originating from the audio detection unit until the operation device transmits a second contact signal indicating that contact by the operator has been removed.

10. The system according to claim 1, wherein the processing unit of the transmission module is configured to perform a plausibility check on the first control signal and the second control signal.

11. The system according to claim 1, wherein the audio detection unit is configured to only transmit a third control signal when a drive gear of the transmission module is engaged in accordance with the second control signal transmitted by the operation device.

12. The system according to claim 1, wherein the communications pathway comprises a gateway.
